(19) United States
(12) Patent Application Publication
(10) Pub. No.: US 2009/0195932 A1
(43) Pub. Date: Aug. 6, 2009

(54) Method and apparatus for an air bearing surface in a hard disk drive using at least one patterned disk surface

(75) Inventor: Shuyu Zhang, Fremont, CA (US)

Correspondence Address: GREGORY SMITH & ASSOCIATES, 3900 NEWPARK MALL ROAD, 3RD FLOOR, NEWARK, CA, 94560, US

(73) Assignee: SAMSUNG ELECTRONICS CO., LTD.

(21) Appl. No.: 12/012,927

(22) Filed: Feb. 5, 2008

(51) Int. Cl. G11B 5/60

(52) U.S. Cl. 360/235.4

(57) ABSTRACT

Estimating methods and apparatus are disclosed for the patterned flying height of an air bearing surface over a patterned surface from the flying height over a smooth surface minus a flying height delta based upon the patterned surface. A hard disk drive is disclosed including the air bearing surface over a rotating disk surface that at least partly includes a patterned surface. A slider with the air bearing surface is disclosed for use over the patterned disk surface. Also disclosed: a head gimbal assembly including the slider and a head stack assembly coupling through the head gimbal assembly to position the slider.

### TECHNICAL FIELD

This invention relates to sliders and their air bearing surfaces in hard disk drives using patterned disk surfaces.

### BACKGROUND OF THE INVENTION

Patterned media recording, such as bit pattern media (BPM) and discrete track recording (DTR), is expected to be used in future hard drives to push the areal density over 500 gigabits per square inch. Because of the patterned feature on the media, each bit is separated from its neighbors either in both radial and circumferential directions (for BPM) or only in radial direction (for DTR), eliminating transition noise in the corresponding direction(s).

However there is a problem, these patterned surfaces increase the difficulty in designing an air bearing surface. While it is theoretically possible to do similar numerical analysis as for smooth surfaces using a very fine grid size, this is uneconomical due to the huge computation resources needed even for a simple, static simulation to execute in the same amount of time. The resource increase is estimated to be at least eight thousand-fold, and it is estimated to be even larger for dynamic simulation of air bearing surfaces over these patterned surfaces. What is needed is a way to solve this problem.

Consider for a moment what causes this problem: The computing resources are needed because contemporary mechanisms for solving fluid dynamic systems frequently divide up the domain of air flow into piecewise approximations over a collection of cells that cover the domain. Fluid dynamic systems may be formulated as a system of partial differential equations representing the compliance of the air flow to certain generally observed physical principles. These principles include conservation laws for mass, energy and/or momentum. The partial differential equations are often formulated around assumptions of compressible and/or incompressible fluids as found in continuum mechanics and sometimes around statistical mechanical assumptions that may account for molecular interactions often within the boundary layer of the overall continuum model.

These piecewise approximations are often formulated as finite difference, finite element and/or finite volume approximations. A finite difference of a function ƒ(x) may be represented as ƒ(x+b)−ƒ(x+a) and the quotient [ƒ(x+b)−ƒ(x+a)]/(b−a) in various forms may be used to represent the derivative ƒ′(x), with more complex quotients being used to represent higher derivatives. The cell in these models is a point arranged in a usually uniform grid. This approach has been in continuous development ever since the dawn of calculus and Newtonian physics. While it has a good deal of appeal for its conceptual simplicity, these models have not tended to converge quickly.

The finite element approach emerged in the 1940's and has been the source of some remarkable improvements. This approach often involves a discrete mesh approximating a continuous domain. The cells may be triangular pyramids arranged with more cells where there is greater need for accuracy to cover a three dimensional domain. Finite element models can frequently account for the varying components of domain such as found in hard disk drives.

The finite volume approach tends to represent and evaluate partial differential equations as algebraic equations evaluated on discrete locations in a geometric mesh. Each location accounts for the fluid flow in a volume about itself, hence the phrase finite volume. In this approach volume integrals in the partial differential equations including a divergence term are replaced with surface integrals that are evaluated as fluxes at the surfaces of each finite volume. Conservation occurs by maintaining that the flux entering each volume must equal the flux leaving the volume. This method is well suited for unstructured meshes such as found in hard disk drives.

### SUMMARY OF THE INVENTION

Embodiments of the invention include methods and apparatus for estimating the flying height of an air bearing surface of a slider over a patterned surface from its flying height over a smooth surface. The flying height over the patterned surface will be referred to as the patterned flying height. Deriving the patterned flying height from the smooth flying height saves a factor of a thousand or more in computing resources.

Embodiments of the invention include a hard disk drive including a voice coil motor pivotably mounted to a disk base to position a slider with an air bearing surface over a rotating disk surface that at least partly includes a patterned surface. The slider's flying height over the patterned surface differs from the flying height over a smooth surface by a flying height delta that is computed from parameters of the patterned surface.

Embodiments of the invention include a slider with an air bearing surface for use in a hard disk drive using a patterned disk surface, where the slider's flying height over the patterned surface differs from the flying height over smooth disk surface by about the pattern depth multiplied by the ratio of the peak area to the total area of the pattern. Other embodiments of the invention may include a head gimbal assembly including the slider, a head stack assembly coupling through the head gimbal assembly to position the slider.

### BRIEF DESCRIPTION OF THE DRAWINGS

FIG. 1 shows a cutaway top view of an example of an embodiment of the invention as a hard disk drive including a voice coil motor pivoting on a disk base to position via a head gimbal assembly, a slider over a rotating disk surface that induces a wind. The disk surface includes at least a portion that is a patterned surface and may or may not include a smooth surface. The rotating disk surface induces a wind that interacts with the slider as will be discussed with regards FIG. 2B to 3.

FIG. 2A shows a perspective view of some details of the voice coil motor of FIG. 1, including a head stack assembly interacting through its voice coil with a fixed magnet assembly. The head stack assembly also includes at least one head gimbal assembly and pivots about an actuator pivot.

FIG. 2B shows a side view of the head gimbal assembly, its slider, and the rotating disk surface. The slider includes a trailing edge intersecting with an air bearing surface that interacts with the wind off the rotating disk surface to create an air bearing by which the slider flies over the disk surface.

FIG. 2C shows a view from the rotating disk surface of a map of an example of the air bearing surface intersecting the trailing edge of the slider of FIG. 2B.

FIG. 3 shows a schematic side view of the disk surface and slider of previous Figures over a smooth surface on the left and over a pattern surface on the right. Over the smooth surface, the trailing edge of the slider flies at a smooth flying height off the smooth surface. Over the patterned surface, the trailing edge is at a patterned flying height. The patterned surface includes a first area at the peak of the patterned surface, which is also called the peak area, a second area at the trough of the patterned surface, which is also called he trough area, a pattern depth, and an average depth. The flying height delta between the smooth flying height and the patterned flying height is based upon the patterned surface and may be approximated by the average pattern depth.

FIGS. 4A and 4B show examples of the bit patterned surface separating bits both in radial and circumferential directions. FIG. 4C shows an example of a discrete track patterned surface separating bits only in the radial direction.

FIG. 5 shows an example embodiment of a system that may implement a method of estimating the patterned flying height based upon the flying height delta and the smooth flying height. The flying height delta may be estimated based upon the pattern depth, the peak area and the trough area of the patterned surface. The smooth flying height may be estimated based upon a parameter list of the air bearing surface representing the map of the air bearing surface as shown in FIG. 2C, possibly using a cellular model of air flow over the smooth disk surface.

FIG. 6 shows some examples of cellular models of slider and its air bearing surface interacting with the wind over the smooth disk surface as shown in FIGS. 2B, 3 and 5, including but not limited to a finite difference model and/or a finite element model and/or a finite volume model.

FIG. 7 shows a flowchart of the program system of FIG. 5 that may include support for estimating the patterned flying height based upon the smooth flying height and the flying height delta. The program system may possibly further include support for calculating the flying height delta and/or the smooth flying height.

And FIG. 8 shows a refinement of the flowchart of FIG. 7 with support for approximately calculating the flying height delta.

### DETAILED DESCRIPTION

This invention relates to sliders and their air bearings in hard disk drives using at least one patterned disk surface. Embodiments of the invention include methods and apparatus for estimating the flying height of an air bearing surface over a patterned surface from the flying height over a smooth surface. The flying height over the patterned surface will be referred to hereafter as the patterned flying height. Deriving the patterned flying height from the smooth flying height saves a factor of a thousand or more in computing resources.

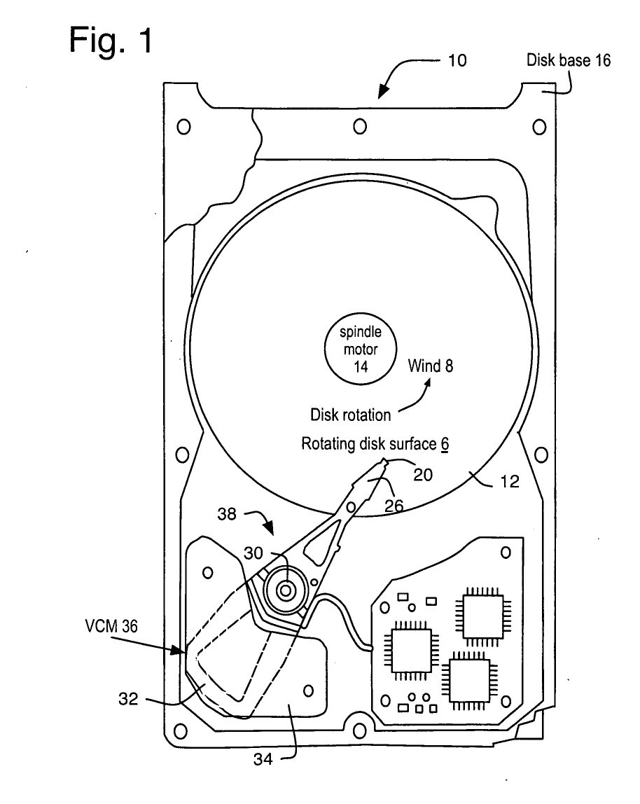

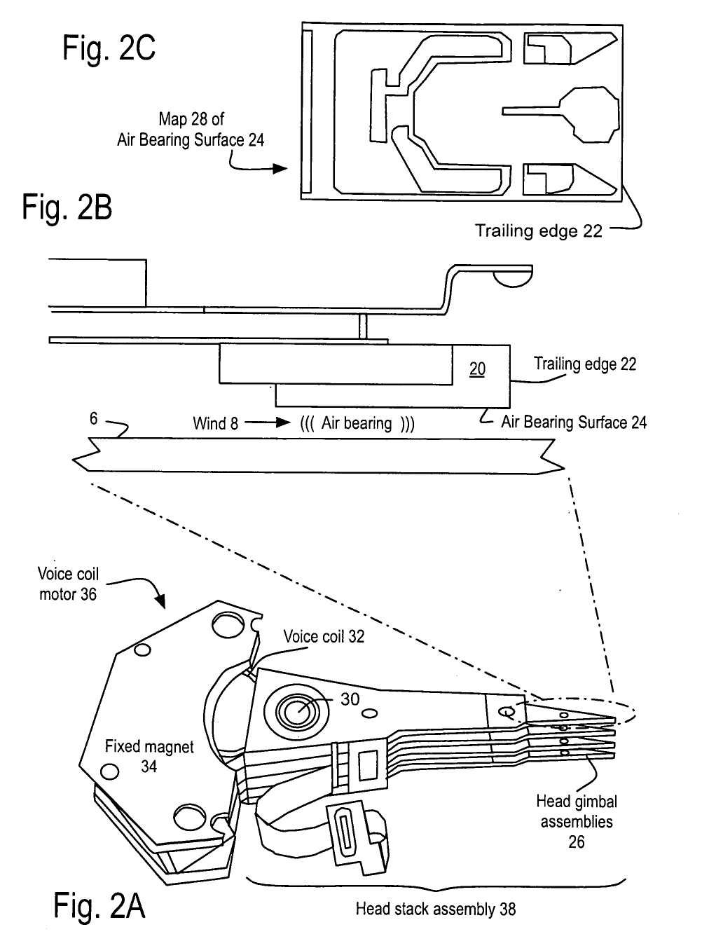

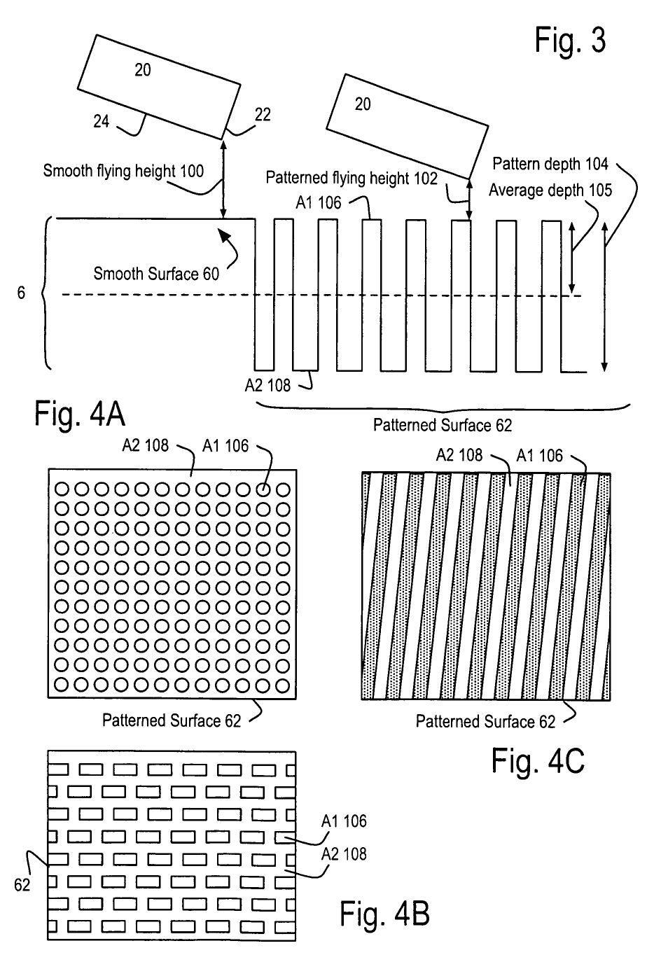

Referring to the drawings more particularly by reference numbers, FIG. 1 shows a cutaway top view of an example embodiment of the invention as a hard disk drive 10 including a disk base 16 and the following components. A spindle motor 14 mounted on the disk base and rotatably coupled to at least one disk 12 to create a rotating disk surface 6. A voice coil motor 36 including a head stack assembly 38 mounted to the disk base by an actuator pivot 30, about which it pivots to position through a head gimbal assembly 26, a slider 20 over the rotating disk surface. The head stack assembly also includes a voice coil 32. The voice coil motor operates when the voice coil is stimulated by a time-varying electrical signal and magnetically interacts with a fixed magnet assembly 34 to move the head gimbal assembly by lever action through the actuator pivot. The disk surface includes at least a portion that is a patterned surface and may or may not include a smooth surface. The rotating disk surface induces a wind 8 that interacts with the slider as will be discussed with regards FIG. 2B to 3.

FIG. 2A shows a perspective view of some details of the voice coil motor 36 of FIG. 1, including the head stack assembly 38 interacting through the voice coil 32 with the fixed magnet assembly 34. The head stack assembly also includes at least one head gimbal assembly 26 and pivots about the actuator pivot 30.

FIG. 2B shows a side view of the head gimbal assembly 26, its slider 20, and the rotating disk surface 6. The slider includes a trailing edge 22 intersecting with an air bearing surface 24 that interacts with the wind 8 off the rotating disk surface to create an air bearing by which the slider flies over the disk surface.

FIG. 2C shows a view from the rotating disk surface 6 of a map 28 of an example of the air bearing surface 24 intersecting the trailing edge 22 of the slider 20 of FIG. 2B. This map is often used in simulations to estimate the flying height of the slider as will now be discussed.

FIG. 3 shows a schematic side view of an example of the slider 20 over the rotating disk surface 6, that includes a smooth surface 60 on the left and a pattern surface 62 on the right. Over the smooth surface, the trailing edge 22 of the slider flies at a smooth flying height 100 off the smooth surface. Over the patterned surface, the trailing edge is at a patterned flying height 102. The patterned surface may include a peak area A1 106 at the peak of the disk surface and a trough area A2 108 at the trough of the disk surface, with a pattern depth 104 and an average pattern depth 105. This average depth 105 may be used as a flying height delta 112 in calculating the patterned flying height 102 from the smooth flying height 100.

Consider the following air flow analysis using FIG. 3. The dimensional equation for air flow pressure may be expressed as

p≈C/h² (1)

Where C is a constant and h refers to the air bearing spacing referred to herein as the flying height. Change in the air bearing spacing may result in a pressure change that may be expressed as

$$Δ p \approx - 2 \frac{p Δ h}{h} \qquad ( 2 )$$

So that the pressure change Δp₁ of the pressure p₁ over the peak 106 of the patterned surface 62 for a flying height h₁ may be expressed as

$$Δ {p}_{1} \approx - 2 \frac{{p}_{1} Δ {h}_{1}}{{h}_{1}} \qquad ( 3 )$$

And the pressure change Δp₂ of the pressure p₂ over the trough 108 of the patterned surface 62 for a flying height h₂ may be expressed as

$$Δ {p}_{2} \approx - 2 \frac{{p}_{2} Δ {h}_{2}}{{h}_{2}} \qquad ( 4 )$$

Assume that the air bearing force does not change after using the average pattern depth 105, which will be denoted as h̅, then

A₁×Δp₁+A₂×Δp₂=0 (5)

By substituting the Δp₁ and Δp₂ into equation (5) we get:

$$\frac{{A}_{1} {p}_{1} Δ {h}_{1}}{{h}_{1}} + \frac{{A}_{2} {p}_{2} Δ {h}_{2}}{{h}_{2}} = 0 \qquad ( 6 )$$

Now applying h₂=h₁−d to equation (6), where d denotes the average height 105, we get:

$$\frac{{A}_{1} {p}_{1} Δ {h}_{1}}{{h}_{1}} + \frac{{A}_{2} {p}_{2} ( Δ {h}_{1} - d )}{{h}_{1} - d} = 0 \qquad ( 7 )$$

Applying Δh=h− h̅ to (7) we get

$$\overline{h} = {h}_{1} + \frac{{A}_{2}}{{{A}_{1} ( 1 + \frac{d}{{h}_{1}} )}^{3} + {A}_{2}} d \qquad ( 8 )$$

Formula (8) leads to replacing the irregular depth of the patterned disk surface with an average depth 105 as:

$$\overline{d} = \frac{{A}_{2}}{{{A}_{1} ( 1 + \frac{d}{{h}_{1}} )}^{3} + {A}_{2}} d \qquad ( 9 )$$

Formula (9) may frequently be approximated by formula (10):

$$\overline{d} \approx \frac{{A}_{2}}{{A}_{1} + {A}_{2}} d \qquad ( 10 )$$

FIGS. 4A to 4C show examples of the patterned surface 62. FIGS. 4A and 4B show examples of the bit patterned surface separating bits both in radial and circumferential directions. FIG. 4A shows circular peak areas A1 106. FIG. 4B shows rectangular peak areas. FIG. 4C shows an example of a discrete track patterned surface separating bits only in the radial direction.

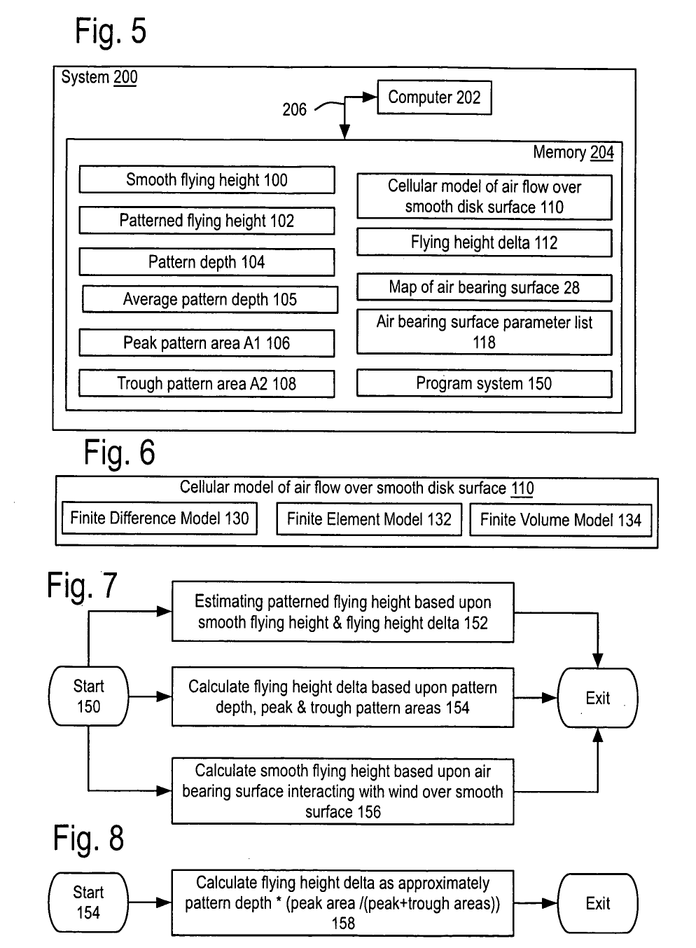

FIG. 5 shows an example embodiment of a system 200 that may implement a method of estimating the patterned flying height 102 based upon a flying height delta 112 and the smooth flying height 100. The flying height delta may be estimated as the average pattern depth 105 based upon the pattern depth 104, the peak area pattern A1 106 and the trough area pattern A2 108 as shown in Formula (9) or (10). The smooth flying height may be estimated based upon a parameter list 118 of the map 28 the air bearing surface 24 as shown in FIG. 2C, possibly using a cellular model 110 of air flow over the smooth disk surface 60.

The system may preferably include at least one computer 202 accessibly coupled 206 via a bus to a memory 204 and instructed by a program system 150 implementing at least part of the methods shown and discussed herein. As used herein, a computer includes at least one data processor and at least one instruction processor instructed by the program system, where each of the data processors is instructed by at least one of the instruction processors. Various embodiments of the system may include more than one computer and may be referred to by some as a parallel processing computer system and/or a server farm in some embodiments of the invention.

FIG. 6 shows some examples of cellular models 110 of the slider 20 and its air bearing surface 24 interacting with the wind 8 over the smooth disk surface 60 as shown in FIGS. 2B, 3 and 5, including but not limited to a finite difference model 130 and/or a finite element model 132 and/or a finite volume model 134.

The following figures show flowcharts of at least one embodiment of the method, which may include arrows signifying a flow of control, and sometimes data, supporting various implementations of the method. These include a program operation, or program thread, executing upon the computer. The operation of starting a flowchart refers to entering a subroutine or a macro instruction sequence in the computer. The operation of termination in a flowchart refers to completion of those operations, which may result in a subroutine return in the computer. The operation of terminating a flowchart is denoted by a rounded box with the word “Exit” in it.

FIG. 7 shows a flowchart of the program system 150 of FIG. 5 that may include program step 152, which supports calculating the patterned flying height 102 based upon the smooth flying height 100 and the flying height delta 112. The program system may possibly further include one or both of the following program steps: Program step 154 supports calculating the flying height delta based upon the pattern depth 104, the peak pattern area A1 106 and the trough pattern area A2 108. Program step 156 supports calculating the smooth flying height 100 based upon the air bearing surface 24 interacting with the wind 8 over the smooth surface 60, with the map of the air bearing surface preferably represented by the parameter list 118 for the air bearing surface.

FIG. 8 shows a refinement of the flowchart of FIG. 7, in particular for program step 154 with support for calculating an approximation of the flying height delta, further comprising the program step 158 supporting the calculation of the flying height delta 112 as shown and discussed regarding formula (10) above. The flying height delta is approximated as the pattern depth 104 multiplied by the ratio of the peak area A1 over the sum of the peak area (A1) and the trough area (A2). In certain alternative embodiments of the invention, Formula (9) may be used to calculate the flying height delta. And in other embodiments, the flying height delta may be further based upon other derivations based upon the pattern surface.

The preceding embodiments provide examples of the invention, and are not meant to constrain the scope of the following claims.

What is claimed is:

1. A hard disk drive, comprising:
a disk base;
a spindle motor mounted on said disk base and rotatably coupled to at least one disk to create a rotating disk surface at least partly including a patterned surface with a peak area, a trough area and a pattern height, said rotating disk surface inducing a wind;
a voice coil motor including a head stack assembly for pivoting about an actuator pivot to said disk base to move a slider with an air bearing surface for interacting with said wind to fly said slider at a flying height above said rotating disk surface, whereby
said flying height over said patterned surface differs from said flying height over a smooth surface by a flying height delta, said flying height delta based upon said patterned surface.

2. The hard disk drive of claim 1, wherein said rotating disk surface includes said smooth surface.

3. The hard disk drive of claim 1, wherein said smooth surface is separate from said hard disk drive.

4. The hard disk drive of claim 1, wherein said patterned surface includes at least one member of the group consisting of a track pattern and a bit pattern.

5. The hard drive of claim 1, wherein said patterned surface has a pattern depth, a peak area and a trough area; and
wherein said flying height delta is based upon said pattern depth, said peak area and said trough area.

6. A head stack assembly, including:
a head gimbal assembly for moving a slider with an air bearing surface for interacting with a wind off a rotating disk surface to fly said slider at a flying height above said rotating disk surface, whereby
said flying height over a patterned surface in said rotating disk surface is the flying height over a smooth surface minus to a flying height delta,
said pattern surface has a peak area, a trough area and a pattern height, and
said flying height delta is based upon said peak area, said trough area and said pattern height.

7. A head gimbal assembly, including:
a slider with an air bearing surface for interacting with a wind off a rotating disk surface to fly said slider at a flying height above said rotating disk surface, whereby
said flying height over a patterned surface in said rotating disk surface is the flying height over a smooth surface minus to a flying height delta,
said pattern surface has a peak area, a trough area and a pattern height, and
said flying height delta is based upon said peak area, said trough area and said pattern height.

8. A method, comprising the step of:
estimating a flying height of a slider with an air bearing surface interacting with a wind over a pattern surface, comprising the step of:
calculating said flying height over said patterned surface based upon a smooth flying height and a flying height delta, said flying height delta based upon said patterned surface.

9. The method of claim 8, wherein said pattern surface has a peak area, a trough area and a pattern height;
said method further comprising the step of:
calculating said flying height delta based upon said peak area, said trough area and said pattern height.

10. The method of claim 9, wherein the step calculating said flying height deference further comprises the step of:
calculating said flying height delta as said peak area multiplied by a ratio of said peak area to a sum of said peak area and said trough area.

11. The method of claim 8, further comprising the step of:
calculating said smooth flying height based upon said air bearing surface interacting with said wind over a smooth surface.

12. A program system for instructing at least one computer through program steps residing in a computer readable memory, comprising the program step of:
estimating a flying height of a slider with an air bearing surface interacting with a wind over a pattern surface with a peak area, a trough area and a pattern height, comprising the program step of:
calculating said flying height over said patterned surface based upon a smooth flying height and a flying height delta.

13. The program system of claim 12, further comprising the program step of:
calculating said flying height delta based upon said peak area, said trough area and said pattern height.

14. The program system of claim 13, wherein the program step calculating said flying height delta further comprises the program step of:
calculating said flying height delta as said peak area multiplied by a ratio of said peak area to a sum of said peak area and said trough area.

15. The program system of claim 12, further comprising the program step of:
calculating said smooth flying height based upon said air bearing surface interacting with said wind over a smooth surface.

16. A system, comprising:
at least one computer accessibly coupled to a computer readable memory and instructed by a program system comprising program steps residing in said computer readable memory, said program system comprising the program step of:
estimating a flying height of a slider with an air bearing surface interacting with a wind over a pattern surface, comprising the step of:
calculating said flying height over said patterned surface based upon a smooth flying height and a flying height delta, said flying height delta is based upon said patterned surface.

17. The system of claim 16, wherein said program system further comprises the program step of:
calculating said smooth flying height based upon said air bearing surface interacting with said wind over a smooth surface.

18. The system of claim 17, wherein the program step calculating said smooth flying height further comprises the program step of:
using a cellular model of air flow over said smooth surface to calculate said smooth flying height.

19. The system of claim 18, wherein said cellular model includes at least one instance of at least one member of the group consisting of: a finite difference model, a finite element model, and a finite volume model.

20. The system of claim 16, wherein pattern surface has a peak area, a trough area and a pattern height that are each used to calculate said flying height delta.
